(19) United States
(12) Patent Application Publication
(10) Pub. No.: US 2021/0262851 A1
(43) Pub. Date: Aug. 26, 2021

(54) WEIGHING SYSTEM AND METHOD

(71) Applicant: ILLINOIS TOOL WORKS INC., Glenview, IL (US)

(72) Inventors: Randy L. BLANKLEY, JR., Springfield, OH (US); Eric D. LANDES, New Carlisle, OH (US); Robert S. DAVIS, Tipp City, OH (US); Douglas J. ANTONIDES, Troy, OH (US); Lawrence A. PEVOAR, Miamisburg, OH (US)

(21) Appl. No.: 16/801,841

(22) Filed: Feb. 26, 2020

(51) Int. Cl. G01G 19/414; H04W 4/35; G06Q 20/20; G06Q 30/06; G07C 11/00

(52) U.S. Cl. CPC G01G 19/4144; H04W 4/35; G07C 2011/04; G06Q 30/0641; G07C 11/00; G06Q 20/208

(57) ABSTRACT

A weighing system for a retail grocery environment is provided. The system includes a scale device with a weighing station and a scale device controller associated with the weighing station for determining a price of an item based upon the item weight, wherein the scale device further includes a first wireless transmitter/receiver associated with the scale controller. A portable, wireless communication module is carried by a scale operator, the wireless communication module including a display screen, a module controller with a memory, at least one operator control input and a second wireless transmitter/receiver.

### TECHNICAL FIELD

This application relates generally to weighing apparatus and, more particularly, to systems incorporating a weighing scale and/or weigh-wrap machine such as those used for retail food stores.

### BACKGROUND

Weighing scales are widely used to accurately measure the weight of goods so that an appropriate price may be assigned to the specific measured weight of the goods. The scales may be stand-alone units, such as those used at the counter of a perishable food department. The scales may also be incorporated into wrapping machines of the type used to wrap, weigh and label food items in the back room of a perishable food department.

Weighing device, whether stand-alone or integrated in a wrapper, have various support needs that require operator intervention. Such weighing devices have the capability to communicate wirelessly to other network computing devices, but such weighing devices lack the ability to communicate directly to retail grocer fresh department employees (supervisors and support personnel) in real-time.

It would be desirable to also provide a low-cost, low-power system that enables retail grocer employees to receive communications directly from such weighing devices to enable an advantageous level of real-time support for such devices in daily grocer operations.

### SUMMARY

In one aspect, a weighing system for a retail grocer environment is provided. The system includes a scale device with a weighing station and a scale device controller associated with the weighing station for determining a price of an item based upon the item weight, wherein the scale device further includes a first wireless transmitter/receiver associated with the scale controller. A portable, wireless communication module is carried by a scale operator, the wireless communication module including a display screen, a module controller with a memory, at least one operator control input and a second wireless transmitter/receiver.

In another aspect, a method of operating a weighing system including a scale device and one or more portable, wireless communication modules, wherein the scale device includes a weighing station and a scale device controller associated with the weighing station for determining a price of an item based upon the item weight, wherein the scale device further includes a first wireless transmitter/receiver associated with the scale controller, wherein the wireless communication module includes a display screen, a module controller with a memory, at least one control input and a second wireless transmitter/receiver.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 shows an exemplary stand-alone scale device;

FIG. 2 shows an exemplary scale device in the form of a weigh/wrap device;

FIG. 3 shows an exemplary retail grocery store layout;

FIG. 4 shows an exemplary portable, wireless communication module for operators;

FIG. 5 shows a schematic of the module;

FIG. 6 shows a schematic of a scale device.

### DETAILED DESCRIPTION

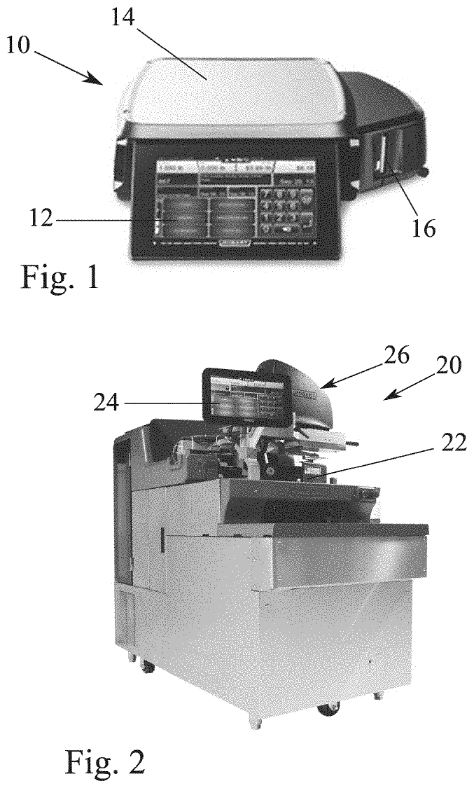

FIG. 1 shows an exemplary assembled food item scale device 10 including a user interface screen 12 (e.g., touch-screen interface), weigh platter 14 and a label printer 16. In a typical item weighing operation, an item is placed on the weigh platter 14, the operator identifies the item to the weighing apparatus (e.g., by inputting an item code via the user interface 12) and the scale controller (e.g., internal) identifies item weight (e.g., based upon internal load cell output), prices the item (e.g., applying a price per unit weight tied to the item codes) and prints and outputs a pricing label for the item (e.g., with item name, weight, price etc.). FIG. 2 shows an exemplary weigh/wrap device 20 that includes a scale integrated into the output conveyor 22 of the device, and that also includes a user interface 24 and label printer and applier 26. As used herein, the term “scale device” is broadly used to refer to both device 10 (e.g., a stand-alone scale) and device 20 (a weigh/wrapper incorporating a scale).

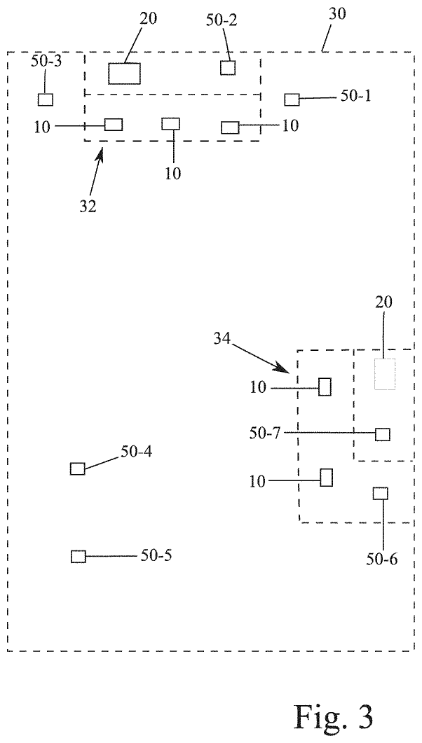

Referring to FIG. 3, an exemplary retail grocer layout 30 is shown, where two perishable departments 32 and 34 are shown (e.g., deli department, fruit and vegetable department, meat and seafood department, bakery department etc.). Each department 30, 32 includes multiple scale devices 10 and at least one scale device 20. The scale devices 20 may typically be located in a backroom of the department, while scale devices 10 may be located at a customer counter or at a customer-accessible station (e.g., in the case of self-service scales). Also illustrated are a plurality of portable, wireless communication modules 50 (50-1, 50-2, 50-3, 50-4, 50-5, 50-6 and 50-7) carried by scale operators (e.g., store personnel working in the department or store personnel responsible for service).

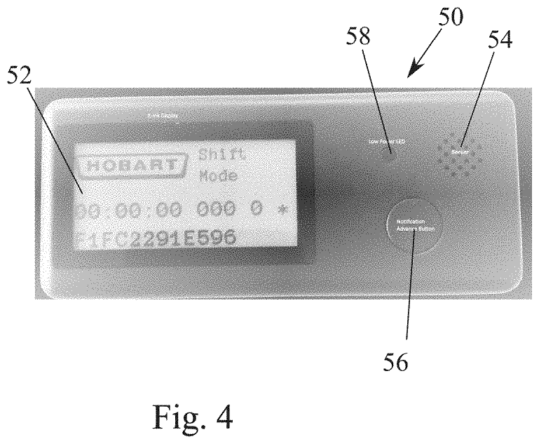

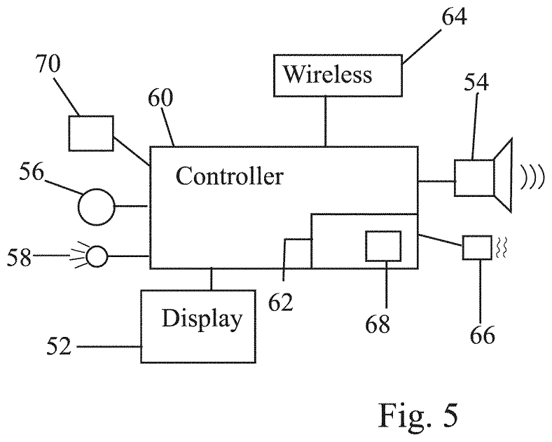

FIG. 4 shows an exemplary wireless communication module 50 that includes a display screen 52, an audio annunciator 54 (e.g., beeper unit), an operator control input 56 (e.g., a push-button) and an LED annunciator 58. The module may be powered by standard batteries that can be replaced as needed. Referring to FIG. 5, an exemplary schematic for the module 50 is shown, depicting a controller 60 along with the other components 52, 54, 56 and 58. The controller 60 includes an associated memory 62 (e.g., flash memory for data persistence) and a wireless communications interface 64 (e.g. wireless transmitter/receiver). A vibration element 66 may also be included in the module.

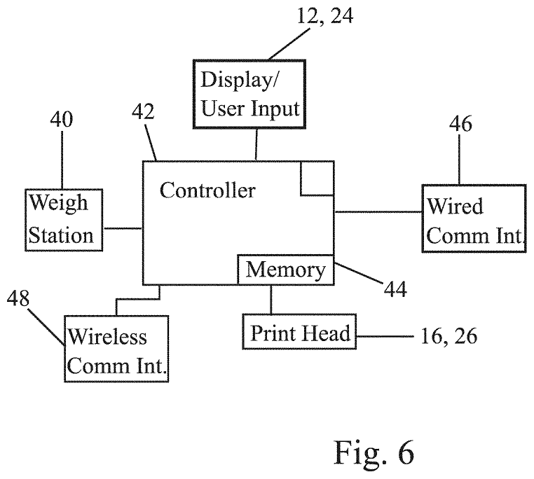

Referring to FIG. 6, an exemplary schematic for a scale device 10, 20 is shown, showing the weighing station 40 (e.g., platter or belt), controller 42 with associated memory 44, a wired communications interface 46, a wireless communications interface 48 (e.g., wireless transmitter/receiver), a user interface 12, 24, and a label printer 16, 26.

The modules 50, may be a minimal footprint device with a persistent display technology that can wirelessly communicate with scale devices 10, 20 (e.g., via the wireless communications interfaces 48 and 64). The wireless technology employed may be Bluetooth Low Energy (BLE). The modules 50 may be configured to transmit identification data to scale devices 10, 20 and each scale device may be configured to transmit messages to those modules 50 the scale devices recognizes as being present (e.g., messages such as notifications and diagnostics, along with scale device identifier and timestamp data) about the scale devices. Typically, the modules 50 within a 20-meter range of a scale device in a typical non-line of sight environment will be recognized and logged as present by the scale device. Thus, in the exemplary layout of FIG. 3 where numerous intervening structures (e.g., display shelves and food items and/or walls) are present, modules 50-1, 50-2 and 50-3 may be recognized as present by the scale devices in department 32, modules 50-6 and 50-7 may be recognized as present by the scale devices in department 34, while the modules 50-4 and 50-5 may not be recognized as present by any scale devices in either of the departments 32 or 34.

The modules 50 are configured to alert (beeping sound and/or vibration) when messages are received and to store the messages in a queue 68 (e.g., a FIFO queue) in the memory 62. The messages can then be sequentially displayed by the module 50 (e.g., any ASCII character text up to 32 characters and two lines of the display). Exemplary messages may include: (i) scale 10 or weigh/wrap unit 20 out of label stock (beneficial for a scale or unattended self-service scale to notify an operator in the department to replace label stock), (ii) weigh/wrap unit out of wrapping film and needs replaced, (iii) scale 10 out of level warning (e.g., as indicated by an on-board accelerometer of the scale), (iv) printhead issue, (v) scale 10 or weigh/wrap device 20 network connectivity status (off or on-line), (vi) scale 10 customer queue size from a queuing management system (e.g., queue size is large and assistance is needed to help customer), (vii) grocer Business/Enterprise or customer help desk originated messages destined for holders of modules, and/or (viii) scale not zero or out of zero maintenance zone for self-service scales.

The modules 50 may have a persistent display screen (e.g., a bistable display device such as e-paper/e-ink technology) so the last notification displayed by the module remains displayed even when the module is powered down. The modules 50 make a beeping sound or vibrate when a new notification is received. The modules 50 provide a button 56 to advance thru pending notifications in the queue to be read. By way of example, module queues 68 may store up to 100 notifications before the oldest notification is removed. The modules 50 may be designed to operate for 6 months (8 hours per day in a 7-day week) without the power source being replaced. The modules 50 may have a method to replace the power source (e.g., Commercial Off-The Shelf batteries) when required. A red LED emitter 58 may flash when the power source is at 10% of maximum capacity and provide a trigger to power the beeper on (operating mode) and off (standby mode). By way of example, the modules 50 may be designed so that the dimensions are less than 4-inch length×1.75-inch width×1 inch deep. A clip to affix the modules to clothing may be provided, or comparable attachment by a lanyard may be provided.

### Exemplary Module Logic

The modules 50 may provide the following implementation in software to perform all its required features. Customer data info and FIFO message queue are stored in the flash memory, so the data is nonvolatile and available when power is cycled. The entire display may be able to be updated. This shall include initial customer data info (e.g. retail grocer name/logo), and when button 56 is first pressed after power on the next FIFO flash message in queue may be displayed with time stamp.

When the module 50 is powered on, the customer data information in the flash memory may displayed on the entire display screen 52. The customer data information in the flash memory may customer logo image and/or text, which is configurable via BLE message, along with Bluetooth MAC Address of the module. The owner or assigned user for the module may also be programmed in the flash memory.

An exemplary display format is as follows:
Line 1—Customer Logo & DB owner.
Line 2—Number of FIFO flash message alerts in Queue and battery status.
Line 3—Module Bluetooth device MAC address.

Each button 56 press after the beeper is powered on and the customer data in flash memory is displayed may sequentially display BLE messages in the FIFO flash message queue one after the other in chronological order received as the module button 56 is pressed. When a new BLE message is received it is placed in the module flash memory FIFO flash message queue, not necessarily displayed, so that the user can choose when to read the queued messages one after the other by depressing the button on the module. The module makes a sound and/or vibrates when a new BLE message alert is received in FIFO flash message queue.

The new BLE message is not necessarily displayed at that time. The alert simply indicates to the user there is yet another message pending to be read in FIFO flash message queue. The button 56, when depressed, advances to the next BLE message received in the FIFO flash message queue and displays and implement the following logic: Line 1 is Time of BLE message received in FIFO flash message queue that is currently displayed and the number of messages still pending in FIFO flash message queue to be read as well as status. Where modules are assigned to specific operators, the operator name may be displayed if there are no pending messages in the device queue (e.g., operator/user name displayed after cycling through the last message in the queue).

Example Display Format on Line 1:
HH:MM:SS [SCALE IDENTIFIER][NUMBER MSGS] [STATUS]
   where—time stamp of message is displayed HH=hours, MM=Minutes, SS=Seconds, [SCALE IDENTIFIER] may be as simple as a store-assigned scale number that is readily known to the module user/operator (e.g., 010, 011 or 012) or may be a scale IP address, and [NUMBER MSGS]=number of messages in FIFO flash message queue that have not been displayed on module screen and read by user. [STATUS] is the status of the module:
      Character 1:
         !=Battery Voltage Level Low, change batteries
         *=Battery Voltage Level OK
      Character 2:
         >=BLE message overflow, messages have been lost due to operator not reading them
         <=BLE messages in message queue and queue has not overflown.

Line 2-N. Contents of the text of the next message received in the FIFO flash message queue. If the number of characters in FIFO flash message queue to display is over maximum that can be displayed on lines 2-N truncate text and place “ . . . ” at end of message when displayed. Maximum number of characters that will fit on these lines.

Once a message in the FIFO flash message queue is displayed, pressing the button 56 on module 56 advances to display the next BLE message and the message that was previously displayed is deleted from the FIFO flash message queue.

The module may be configured to power off after a specified time (N minutes) configurable via received BLE message, to save battery life. In addition, as another power saving feature, the modules may include an accelerometer 70 (FIG. 5) to detect motion of the module, with the controller configured to monitor the accelerometer output and to turn the module off (into the standby mode) if the accelerometer fails to indicate module motion after a predetermine time period (e.g., if the accelerometer fails to indicate motion for a period of five minutes). The predetermined time period may be adjusted by, for example, Bluetooth download. The module may include a beeper software logic program programmable/updatable via a USB port and BLE message download. A software programmer's Application Programmer's Interface (API) may be provided documenting the specified programming information and interface.

As discernible from the above description, a weighing system for a retail grocer environment is provided. The system includes a scale device 10, 20 with a weighing station and a scale device controller associated with the weighing station for determining a price of an item based upon the item weight, wherein the scale device further includes a first wireless transmitter/receiver associated with the scale controller. A portable, wireless communication module is carried by a scale operator, the wireless communication module including a display screen, a module controller with a memory, at least one operator control input and a second wireless transmitter/receiver. The wireless communication module includes an operating mode in which the module controller is configured to operate the second wireless transmitter/receiver to wirelessly communicate a distinct identifier specific the wireless communication module. The scale device includes an operating mode in which the scale device controller is configured to: (i) monitor the first wireless transmitter/receiver and, upon receipt of the distinct identifier, log the wireless communication module as available for communications; and (ii) selectively send messages to the wireless communication module upon identification of certain scale device events, each message including at least scale device identification data and scale device event data. In the operating mode of the wireless communication module, the module controller is configured such that, upon receipt of each message from the scale device, the message is loaded into a FIFO queue in the memory. In the operating mode of the wireless communication module, the module controller is configured such that, upon triggering of the operator control input, a next message in the FIFO queue is presented on the display screen.

The display screen of the wireless communication module may be a low power consumption bistable display device, such as e-paper. The memory of the module controller may be a flash memory. The wireless communication module may include a standby mode and, in the standby mode, a last message presented on the display screen remains active for viewing.

The flash memory may also store the distinct identifier and/or other data identifying the scale operator carrying the wireless communication module. In the standby mode of the wireless communication module, the module controller is configured such that an initial triggering of the operator control input places the wireless communication module into the operating mode and causes the distinct identifier and/or the other data identifying the scale operator to be presented on the display screen.

The flash memory may also store data identifying a retail grocer in which the weighing system is located. In the standby mode of the wireless communication module, the module controller is configured such that the initial triggering of the operator control input causes the data identifying the retail grocer to be presented on the display screen. In the operating mode of the wireless communication module, when a given next message in the FIFO queue is presented on the display screen, the preceding message is eliminated from the FIFO queue.

In the operating mode of the wireless communication module, the module controller may be configured to operate the second wireless transmitter/receiver to wirelessly communicate, along with the distinct identifier, data indicating a number of messages in the FIFO queue that have not yet been presented on the display screen.

The scale device controller may be configured such that each message sent to the wireless communication module also includes timestamp data, wherein the module controller is configured such that each message from the FIFO queue that is presented on the display screen includes display of the timestamp data.

The scale device may be either a stand-alone scale or part of a weigh/wrap device, wherein the scale device controller is configured to identify two or more of the following scale events and to send a message to the wireless communication module indicating such identified scale events:
(i) scale device out of label stock;
(ii) scale device out of film;
(iii) scale device out of level;
(iv) scale device printhead issue;
(v) scale device network connectivity status;
(vi) scale device customer queue size;
(vii) receipt of a retail grocer or customer help desk originated message for the scale operator; or
(viii) scale device not zero or out of zero maintenance zone.

The scale device controller may be configured to operate such that, if a given scale device event associated with a message previously sent to the wireless communication device is later addressed or solved, the scale device controller operates the first wireless transmitter/receiver to send an update message to the wireless communication module identifying that the given scale device event has been addressed or solved.

The described system also provides a method of operating a weighing system including a scale device and one or more portable, wireless communication modules, wherein the scale device includes a weighing station and a scale device controller associated with the weighing station for determining a price of an item based upon the item weight, wherein the scale device further includes a first wireless transmitter/receiver associated with the scale controller, wherein the wireless communication module includes a display screen, a module controller with a memory, at least one control input and a second wireless transmitter/receiver. The method involves: the wireless communication module operating the second wireless transmitter/receiver to wirelessly communicate to the scale device a distinct identifier specific the wireless communication module; the scale device operating to log presence of the wireless communication module; the scale device further operating to: (i) identify scale message events and (ii) for each identified scale message event, operate the first wireless transmitter/receiver to send a message to the wireless communication module; the wireless communication module operating to store each message received from the scale device in a message queue in the memory; and the wireless communication module further operating to present on the display screen a next message in the message queue upon triggering of the control input.

As used herein, the term controller is intended to broadly encompass any circuit (e.g., solid state, application specific integrated circuit (ASIC), an electronic circuit, a combinational logic circuit, a field programmable gate array (FPGA)), processor(s) (e.g., shared, dedicated, or group—including hardware or software that executes code), software, firmware and/or other components, or a combination of some or all of the above, that carries out the control functions of the device/machine or the control functions of any component thereof.

It is to be clearly understood that the above description is intended by way of illustration and example only, is not intended to be taken by way of limitation, and that other changes and modifications are possible. For example, the wireless modules and scale devices may also utilize the Bluetooth technology to login operators to the scale devices (e.g., when the scale device determines that the module is within a certain distance of the scale device, such as 20-36 inches).

What is claimed is:

1. A weighing system in a retail grocer environment, comprising:
a scale device with a weighing station and a scale device controller associated with the weighing station for determining a price of an item based upon the item weight, wherein the scale device further includes a first wireless transmitter/receiver associated with the scale controller;
a portable, wireless communication module carried by a scale operator, the wireless communication module including a display screen, a module controller with a memory, at least one operator control input and a second wireless transmitter/receiver;
wherein the wireless communication module includes an operating mode in which the module controller is configured to operate the second wireless transmitter/receiver to wirelessly communicate a distinct identifier specific the wireless communication module;
wherein the scale device includes an operating mode in which the scale device controller is configured to:
(i) monitor the first wireless transmitter/receiver and, upon receipt of the distinct identifier, log the wireless communication module as available for communications;
(ii) selectively send messages to the wireless communication module upon identification of certain scale device events, each message including at least scale device identification data and scale device event data;
wherein, in the operating mode of the wireless communication module, the module controller is configured such that, upon receipt of each message from the scale device, the message is loaded into a FIFO queue in the memory;
wherein, in the operating mode of the wireless communication module, the module controller is configured such that, upon triggering of the operator control input, a next message in the FIFO queue is presented on the display screen.

2. The weighing system of claim 1, wherein the display screen of the wireless communication module is a low power consumption bistable display device, such as e-paper.

3. The weighing system of claim 2, wherein the memory of the module controller is a flash memory.

4. The weighing system of claim 3, wherein, the wireless communication module includes a standby mode and, in the standby mode, a last message presented on the display screen remains active for viewing.

5. The weighing system of claim 4, wherein the flash memory also stores the distinct identifier and/or other data identifying the scale operator carrying the wireless communication module, wherein, in the standby mode of the wireless communication module, the module controller is configured such that an initial triggering of the operator control input places the wireless communication module into the operating mode and causes the distinct identifier and/or the other data identifying the scale operator to be presented on the display screen.

6. The weighing system of claim 5, wherein the flash memory also stores data identifying a retail grocer in which the weighing system is located, wherein, in the standby mode of the wireless communication module, the module controller is configured such that the initial triggering of the operator control input causes the data identifying the retail grocer to be presented on the display screen.

7. The weighing system of claim 1, wherein, in the operating mode of the wireless communication module, when a given next message in the FIFO queue is presented on the display screen, the preceding message is eliminated from the FIFO queue.

8. The weighing system of claim 1, wherein, in the operating mode of the wireless communication module, the module controller is configured to operate the second wireless transmitter/receiver to wirelessly communicate, along with the distinct identifier, data indicating a number of messages in the FIFO queue that have not yet been presented on the display screen.

9. The weighing system of claim 1, wherein the scale device controller is configured such that each message sent to the wireless communication module also includes timestamp data, wherein the module controller is configured such that each message from the FIFO queue that is presented on the display screen includes display of the timestamp data.

10. The weighing system of claim 9, wherein the scale device is either a stand-alone scale or part of a weigh/wrap device, wherein the scale device controller is configured to identify two or more of the following scale events and to send a message to the wireless communication module indicating such identified scale events:
(i) scale device out of label stock;
(ii) scale device out of film;
(iii) scale device out of level;
(iv) scale device printhead issue;
(v) scale device network connectivity status;
(vi) scale device customer queue size;
(vii) receipt of a retail grocer or customer help desk originated message for the scale operator; or
(viii) scale device not zero or out of zero maintenance zone.

11. The weighing system of claim 9, wherein the scale device controller is configured to operate such that, if a given scale device event associated with a message previously sent to the wireless communication device is later addressed or solved, the scale device controller operates the first wireless transmitter/receiver to send an update message to the wireless communication module identifying that the given scale device event has been addressed or solved.

12. The weighing system of claim 1, wherein the wireless communication module includes an accelerometer, and the module controller is configured such that, in the operating mode, if the accelerometer fails to indicate module motion for a predetermined time period, the controller places the wireless communication module into a standby mode in order to save power.

13. A method of operating a weighing system including a scale device and one or more portable, wireless communication modules, wherein the scale device includes a weighing station and a scale device controller associated with the weighing station for determining a price of an item based upon the item weight, wherein the scale device further includes a first wireless transmitter/receiver associated with the scale controller, wherein the wireless communication module includes a display screen, a module controller with a memory, at least one control input and a second wireless transmitter/receiver, where the method comprises:
the wireless communication module operating the second wireless transmitter/receiver to wirelessly communicate to the scale device a distinct identifier specific the wireless communication module;
the scale device operating to log presence of the wireless communication module;
the scale device further operating to:
(i) identify scale message events;
(ii) for each identified scale message event, operate the first wireless transmitter/receiver to send a message to the wireless communication module;
the wireless communication module operating to store each message received from the scale device in a message queue in the memory;
the wireless communication module further operating to present on the display screen a next message in the message queue upon triggering of the control input.

14. The method of claim 13, wherein the display screen of the wireless communication module is a low power consumption bistable display device, wherein the memory of the module controller is a flash memory, and wherein the message queue is a FIFO queue.

15. The method of claim 14, wherein the scale device operates such that each message sent to the wireless communication module includes scale device identification data, scale device event data, and timestamp data, wherein the wireless communication module operates such that each message from the FIFO queue that is presented on the display screen includes the scale device identification data, the scale device event data and the timestamp data.

16. The method of claim 13, wherein the wireless communication module includes an accelerometer and is battery powered, wherein the wireless communication module operates such that, if the accelerometer does not indicate module motion for a predetermined time period, the wireless communication module is placed into a standby mode to reduce power consumption, and in the standby mode the wireless communication module no longer receives and stores messages from the scale device.
